(19) United States
(12) Patent Application Publication
(10) Pub. No.: US 2023/0249523 A1
(43) Pub. Date: Aug. 10, 2023

(54) Air Vent with Adjustable Air Outlet Direction, in Particular Flat or Joint Flows

(71) Applicant: Weber GMBH & Co., KG, Dillenburg (DE)

(72) Inventor: Markus RIESS, Eschenburg-Wissenbach (DE)

(73) Assignee: Weber GMBH & Co., KG, Dillenburg (DE)

(21) Appl. No.: 18/064,363

(22) Filed: Dec. 12, 2022

(30) Foreign Application Priority Data
Feb. 9, 2022 (DE) 102022111454.6

(51) Int. Cl. B60H 1/34

(52) U.S. Cl. CPC B60H 1/3414; B60H 2001/3471

(57) ABSTRACT

An air vent (10) such as a flat or joint vent has an adjustable air-outflow direction (9) to direct an airstream. An air-deflection area (4) between the air inlet opening (2) and the air outlet opening (3) sets the air-outflow direction (9) at the air outlet opening (3). At least one regulation means (7) in the air-deflection area (4) is arranged in the flow channel (1) in order to influence the geometry of the flow channel. The at least one regulation means (7) is essentially tubular and elastically deformable. The at least one regulation means (7) splits the airstream (15) into partial streams (21) that flow through the regulation means (7).

### BACKGROUND OF THE INVENTION

Technical Field and State of the Art

The invention relates to an air vent, also referred to as a supply-air grille, with adjustable air-outflow direction, especially to flat or joint vents according to the generic part of claim 1 as well as to a method according to the generic part of claim 13 for directing an airstream by means of such an air vent.

Air vents can be used, for example, in vehicles, especially motor vehicles, and they generally serve to regulate the airstream flowing out of an air outlet opening in the horizontal and/or vertical directions. The air vent can be arranged, for instance, in the dashboard of a motor vehicle.

Flat or joint vents are characterized in that their height is smaller than their width, exhibiting, for example, a height-to-width ratio of about 1:6 to about 1:7. When it comes to such prior-art flat or joint vents, there is often an air-control element air-control element that extends along the entire width. Several pivotable parallel lamellas can be mounted on bearings in the viewing direction onto the vent behind the air-control element or in the flow direction of the air in front the air-control element.

The state of the art comprises several devices and methods for adjusting an airstream.

In the prior-art air vents, air-control elements or lamellas oriented vertically and horizontally can be arranged one after the other. As a rule, an adjustment mechanism allows the horizontal as well as the vertical lamellas to be pivoted separately or jointly in order to adjust the direction of the outflowing air.

German patent application DE 10 2017 111 011 A1 discloses an air vent that, in the air-outflow direction, has two first air-control elements that are mounted upstream from an air outlet opening and from a front section of an air channel of the air vent. The first air-control elements are arranged in such a way that they reduce the cross section of the air channel, wherein the pivoting axes of the first air-control elements run through the end faces of the first air-control elements facing away from the air outlet opening.

German patent application DE 10 2017 113 906 A1 discloses an air vent comprising an air-control element and a blocking mechanism, wherein the air-control element is arranged in the area of an air outlet opening, and the blocking mechanism is situated upstream from the air-control element. The blocking mechanism has a blocking wall so that an air channel of the air vent can be completely closed off by means of the blocking wall.

German patent (2^{nd} publication) DE 10 2015 118 548 B4 discloses an air vent having a control apparatus for controlling the direction and volume of the air flowing out of an air vent. The air vent is configured in the form of a single-button operation. For this purpose, the air vent has at least one control lamella pivotably mounted in a housing, and second lamellas that run orthogonally to the control lamella and that are pivotably mounted in the housing, whereby the direction of the airstream flowing out of the housing can be adjusted by means of the control lamella and the second lamellas, while the volume of outflowing air can be additionally adjusted by means of the second lamellas.

European patent specification EP 2 993 068 B1 discloses an air vent having at least two air-control elements that are arranged essentially parallel to each other and having pivotable lamellas arranged at a right angle to the air-control elements. Likewise provided is a housing with an air inlet area, an air outlet area and an air channel situated between the air inlet area and the air outlet area. The at least two air-control elements have a first, second and third section wherein the sections are joined to each other so as to be pivotable.

German patent (1^{st} publication) DE 10 2013 210 055 B3 discloses an air vent having a housing, an air inlet opening situated in the axial direction relative to the housing and an air outlet opening located opposite from the air inlet opening. Likewise provided in the housing is an air-control element with a first air-guiding surface and a second air-guiding surface that is opposite from the first air-guiding surface and that is symmetrical to the first air-guiding surface, wherein a first air channel is formed through the housing and the first air-guiding surface. A second air channel is formed through the housing and the second air-guiding surface. Moreover, a first wing is provided that is movably arranged on the end of the air-control element facing the air inlet opening. The mobility of the first wing is configured in such a way that the ratio of a first volume stream in the first air channel relative to a second volume stream in the second air channel can be set on the basis of the position of the first wing.

German patent (1^{st} publication) DE 10 2007 019 602 B3 likewise discloses an air vent with a nozzle housing, an air inlet opening situated in an axial direction relative to the nozzle housing, an air outlet opening situated opposite from the air inlet opening, and a tapered air-control element. The nozzle housing and the air-control element are configured to generate the Coandă effect so that a directed jet of air exits the air outlet opening.

German patent application DE 10 2006 032 587 A1 discloses an air vent device for vehicles, comprising an air channel, an air inlet opening via which, in the state installed in the vehicle, air flows out of the air channel into the passenger compartment of the vehicle, as well as a lamella-like air-control element arranged between the two wall areas and the area of the air outlet opening. The air-control element consists of two parts and it has a front lamella section and a rear lamella section that is joined thereto in the manner of a hinge.

German utility model DE 20 2012 100 980 U1 describes a single-button operating apparatus for an air vent, whereby, in order to for the airstream to be regulated, the direction of lamellas that can be pivoted in a first and second directions can be changed and the volume of the outflowing air can be regulated by means of a closing mechanism. The lamellas can be arranged essentially horizontally and vertically or else at a certain angle with respect to each other. The apparatus also comprises an operating element with which the lamellas that run in the first and second directions can be oriented, and also a ring-shaped operating wheel with which the volume of the air flowing out through the closing mechanism is regulated.

German patent application DE 10 2015 101 097 A1 discloses an air element that is made of a flexible material and that is accommodated in a housing, wherein the air-control element has a first end section that can be mounted on bearings in the housing and a second end section situated opposite from the first end section. The second end section can be mounted on bearings in the housing, whereby the force exerted onto the air-control element by at least one force component deforms the air-control element at least in one area between the first end section and the second end section, and wherein the air-control element has at least one opening extending perpendicular to the lengthwise direction of the air-control element.

German patent application DE 10 2012 019 024 A1 discloses a geometrically deformable air-control element that serves to control and/or guide fluid streams and that comprises at least one dielectric elastomer actuator as well as at least one element to exert a mechanical actuating force onto the dielectric elastomer actuator. The application of an electric voltage causes the length of the dielectric elastomer actuator to change in at least one direction; this deformation allows the fluid streams to be controlled in a targeted manner.

German patent application DE 10 2013 108 059 A1 relates to an air-control element made of a flexible material for an air vent as well as to an air vent, wherein at least one air-control element is mounted on bearings in a first end section, and at least one second end section situated opposite from the first end section is supported in such a way that the effect of at least one force component onto an area of the air-control element between the first end section and the second end section causes the air-control element to deform at least in this area, and once the effect of the force component has ended, the air-control element returns of its own accord to the initial position.

For the rest, air vents are disclosed in Japanese documents laid open to public inspection JP 2006 30 6365 A, JP S60 169 044 A, French application for patent of invention FR 2 872 260 A1 and German patent (second publication) DE 199 43 822 B4.

Prior-art air vents, especially so-called flat or joint vents, have a narrow air outlet opening. Moreover, the prior-art flat vents require two joints in order to ensure deflection of the outflowing air towards the top and the bottom.

A disadvantage of such air vents is that a great deal of effort is required to minimize pressure losses, to optimize the flow rates and to reduce flow noises. Moreover, due to the numerous parts needed, the production of such an air vent entails high costs.

Furthermore, the complex structure entailing intricate kinematics associated with the prior-art air vents is a drawback.

### SUMMARY OF THE INVENTION

Before the backdrop of the disadvantages described above, the invention is based on the objective of putting forward an improved air vent that entails a small installation height and a simple structure, and also of putting forward an improved method to direct an airstream.

The invention relates to an air vent with adjustable air-outflow direction, especially flat or joint vents, comprising a flow channel having an air inlet opening and an air outlet opening located essentially opposite from the air inlet opening, especially an air outlet joint, whereby an airstream can flow in a flow direction through the air inlet opening into the flow channel and then flow out through the air outlet opening, comprising an air-deflection area arranged between the air inlet opening and the air outlet opening for purposes of setting the direction of the air outflow at the air outlet opening, wherein at least one regulation means is arranged in the flow channel in the air-deflection area in order to influence the geometry of the flow channel.

As mentioned, flat and joint vents are characterized in that their height is smaller than their width, exhibiting, for example, a height-to-width ratio of about 1:6 to about 1:7. Preferably, the width of the air vent can be about 180 mm at a height of about 30 mm. As an alternative, the air vent can also be arranged so as to run orthogonally or even diagonally, so that the width-to-height ratio of the air vent changes in accordance with the arrangement.

According to the invention, the at least one regulation means that serves to split the airstream into partial streams that flow through the regulation means and to guide the partial streams is configured to be elastically deformable and essentially tubular in shape. In other words, the partial stream of air flows through the tubular regulation means.

Accordingly, the at least one regulation means has a reversibly changeable geometric shape. As a result, the direction of the airstream or of the partial streams can be changed very easily without necessitating intricate kinematics. The direction of the partial stream flowing through the regulation means can thus be systematically changed by changing the shape of the regulation means.

The term directional vector of an airstream refers to the direction and the volume of the airstream. The airstream is split into partial streams by the at least one regulation means. The directional vector of the airstream flowing out of the outlet opening can be altogether influenced by splitting the airstream into at least two partial streams. In other words, the airstream direction of each partial stream can be set at the air outlet opening by means of the at least one elastically deformable regulation means.

In the case of several regulation means, the airstream is split correspondingly into so many partial streams, each of which flows through a tubular regulation means.

As mentioned above, due to the reversibly deformable design, the regulation means work together in such a way that the flow channel geometry is altogether changed employing simple means. In other words, in this manner, the direction of the airstream or of the individual airstreams can be changed in a simple way by changing the geometry of the regulation means. The advantageous material properties of elastomers in terms of their reversibility are utilized in order to ensure these requirements.

The at least one tubularly configured regulation means preferably has an approximately circular cross section. The tubular regulation means is hollow in order to allow the through-flow of the partial streams. The wall thickness of the regulation means can vary.

A control or adjustment element can be connected to the tubular, elastically deformable regulation means or air-control elements in order to adjust these elements in the Y and Z directions, that is to say, longitudinally and crosswise to the air outlet opening, for example, to an air outlet joint so that the airstream is correspondingly adjusted. For this purpose, an adjustment or shifting of the control or adjustment element can be transmitted to these elastically deformable regulation means.

The airstream flows through the air inlet opening and is then split by the regulation means into partial streams, the latter, in turn, being guided by the geometric shape of the elastically deformable regulation means in the air-deflection area of the air vent to the air outlet opening, from where it then flows out.

The tubular, elastically deformable regulation means entail advantages that translate into the realization of much simpler kinematics in comparison to the state of the art, allowing “soft” air guidance. In other words, a “hard” transition of the airstream is prevented and a “soft” guidance of the airstream is ensured, especially one without hard edges on the components such as, for instance, flaps or the like. Moreover, the utilization of identical parts reduces the production costs. Furthermore, a joint air vent having only one joint is possible in this manner, as a result of which the esthetics of the vent are improved.

According to a first advantageous embodiment of the invention, the at least one regulation means is configured as an elastic tubular element, preferably in the form of a silicon tube. Preferably, several regulation means can be formed by elastic tubular elements, preferably silicon tubes, arranged essentially in parallel to each other.

Thanks to this configuration, particularly without complex flap and lamella constructions, the air vent entails few structural components, so that the costs for the production and for the assembly of the air vents are further reduced. Moreover, undesired disturbing sounds such as rattling of the components or whistling noises are prevented. Silicon has a high temperature resistance that properly meets the requirements made of an air vent (supply air grille), typically −30° C. to +90° C.

According to another advantageous variant of the invention, the at least one regulation means extends in the flow channel essentially from the air inlet opening to the air outlet opening; particularly in a basic position of the regulation means, the partial streams flowing or being guided through the regulation means flow from the air inlet opening to the air outlet opening essentially without being deflected.

Owing to the undeflected flow of the airstream through the air vent, the dynamic pressure decreases, while accordingly the venting-cooling-heating output of the system increases and the noises of the entire system are reduced.

According to an advantageous embodiment of the invention, for purposes of setting the air-outflow direction, the air vent has an adjustment element that is operationally connected to the at least one elastically deformable regulation means and that serves to reversibly change the geometric shape of the at least one regulation means.

In particular, the adjustment element is mechanically operationally connected to the at least one regulation means.

In other words, the at least one regulation means is coupled to the adjustment element in such a way that especially an adjustment or shifting of the adjustment element brings about a change in the shape of the regulation means. For instance, shifting of the adjustment element causes a change in the geometry of the elastically configured regulation means, so that the partial streams or the airstream altogether are deflected to a desired direction. The geometry of the regulation means can exhibit partial areas that have, for example, a convex or concave shape, so that the airstream can be guided accordingly.

Some requirements for deflecting the airstream in the air vent are, for instance, deflection of the airstream to a “draft-free” position, especially above the head of the vehicle occupants or a “draft-free” position on the side next to the hand surfaces of the driver of the vehicle.

For instance, the adjustment element can be deflectable to at least one direction and to another direction perpendicular to this direction in order to change the geometric shape of the at least one reversibly changeable regulation means on at least two planes that are preferably situated approximately perpendicular to each other.

It is advantageous that the adjustment means can be operated outside of the air outlet opening of the air vent. The adjustment can be carried out, for example, mechanically or electrically by means of an actuator.

According to another embodiment of the invention, the adjustment element can be employed to set the regulation means between a basic position in which the airstream or the partial streams flow from the air inlet opening to the air outlet opening essentially without deflection, and a deflected position in which the geometry of the at least one regulation means is reversibly deformed with respect to the basic position.

According to an advantageous embodiment, it is provided that, in order for the direction of the airstream or of the partial streams to be set, an operating element that is arranged especially in the area of the air outlet opening is coupled to the adjustment element.

The operating element can be activated, for instance, mechanically by means of pivot joints or slide elements.

Electric activation by means of actuators would be likewise conceivable.

In this context, activation that is independent of the position of the air vent is advantageous. By the same token, several air vents can be activated by means of a single actuator. Automatic activation via the air-conditioning unit of the vehicle is also possible.

In an advantageous variant of the invention, the air vent has a housing with an air inlet opening and an air outlet opening, thus allowing a very simple installation, for example, in a motor vehicle. Moreover, the components of the air vent are then protected against external influences.

Especially advantageous is an embodiment of the invention in which, for purposes of improving the laminar flow of the partial streams, the housing widens, at least in some sections, in the air-deflection area, especially so as to be curved convexly outwards. This makes use of the so-called Coandă effect. The term Coandă effect generally designates a phenomenon in which a jet of gas runs along a surface without detaching from it. The flow, for example, in the form of an airstream, follows a convex surface contour without detaching from this contour. In the case of outflowing airstreams that are based on the Coandă effect, it is easy to guide the direction of the airstream without the need to employ a laborious construction with lamellas and air-control elements.

In an advantageous refinement of the invention, the air vent has at least one receptacle means for the at least one regulation means, especially for at least one first end of the at least one regulation means. It can be provided for the at least one receptacle means to be movable, especially slidable, relative to the housing of the air vent in order to allow a linear compensation in the case of a reversible change in the geometric shape of the at least one regulation means.

In particular, it is conceivable for the at least one regulation means to be held in the flow channel in the area of its leading edge by at least one bearing point configured as a receptacle means and/or by at least one bearing point configured as a receptacle means in the area of the air outlet opening. In particular, the regulation means can be held so that it can be slid. In this manner, the reversible properties of the regulation means can be implemented very effectively.

Due to the slidable accommodation of the regulation means, the requirements made of the tubular regulation means, for example, the elasticity of the silicon tube, are diminished. Moreover, the operating forces are also reduced. By the same token, the possibility is created to regulate the operating forces on the basis of the resistance level of the sliding.

According to an advantageous embodiment of the invention, a center lamella is provided in the flow direction at the end of the air-deflection area of the partial streams; in particular, the operating element is coupled to the center lamella. It is conceivable for the operating element to have a gearwheel or toothed segment, so that this connection is implemented in the form of a gearwheel connection.

This entails the advantage that the airstream through this center lamella can also be additionally deflected in a flow direction crosswise or perpendicular to the direction of flow through the partial channels. As seen from the perspective of a user, for example, in a motor vehicle, the airstream can be deflected by means of the center lamella, for instance, to the side, in other words, to the left and to the right.

In such a case, the flow direction established by the air-deflection area and by the regulation means would run orthogonally thereto, in other words, upwards and downwards, so that a deflection of the airstream is possible in the horizontal direction, in other words, also in the vertical direction relative to the outlet opening of the air vent, that is to say, air deflection is possible in all spatial directions. As set forth in the invention, it would also be conceivable for the air vent to be arranged in such a way that, from the operator's perspective, the deflection in the vertical direction, in other words, from the top to the bottom, brought about by the center lamella, and the deflection direction effectuated by the regulation means are then in the horizontal direction as seen by the user.

A refinement of the invention provides for at least one reversibly deformable regulation means to be made of an elastomer, especially a thermoplastic elastomer (TPE), preferably a polyurethane-based thermoplastic elastomer (TPU), or else for it to contain an elastomer. TPE and TPU are materials that can be processed by means of injection molding, and consequently allow greater design freedom in comparison to extruded tubes.

An independent idea of the invention relates to a method for directing an airstream, employing an air vent, especially of the type described above, with adjustable air-outflow direction, preferably a flat or joint air vent, whereby the airstream enters a flow channel via an air inlet opening, and exits the flow channel via an air outlet opening, especially an air outlet joint, whereby the airstream exerts an influence in an air-deflection area in the flow channel by reversibly changing the geometric shape of at least one essentially tubular regulation means so as to change the geometry of the flow channel, particularly in that partial streams flowing through the regulation means are split and guided.

In accordance with a first advantageous embodiment of the method according to the invention, the reversible change in the geometric shape is an elastic deformation.

Additional objectives, advantages, features and application possibilities of the present invention ensue from the description below of an embodiment making reference to a drawing. In this context, all of the described and/or depicted features, either on their own or in any meaningful combination, constitute the subject matter of the present invention, also irrespective of their compilation in the claims or the claims to which they refer back.

### DESCRIPTION OF THE DRAWINGS

In this context, the following is depicted, at times schematically:

FIG. 1 an air vent with regulation means, in a basic position,

FIG. 2 the air vent as shown in FIG. 1, in a deflected position,

FIG. 3 another embodiment of the air vent with a center lamella, in the basic position, and

FIG. 4 the air vent as shown in FIG. 3, in a deflected position.

### DETAILED DESCRIPTION

For the sake of clarity, identical or functionally identical parts are provided with appropriate reference numerals in the figures of the drawing shown below, making reference to an embodiment.

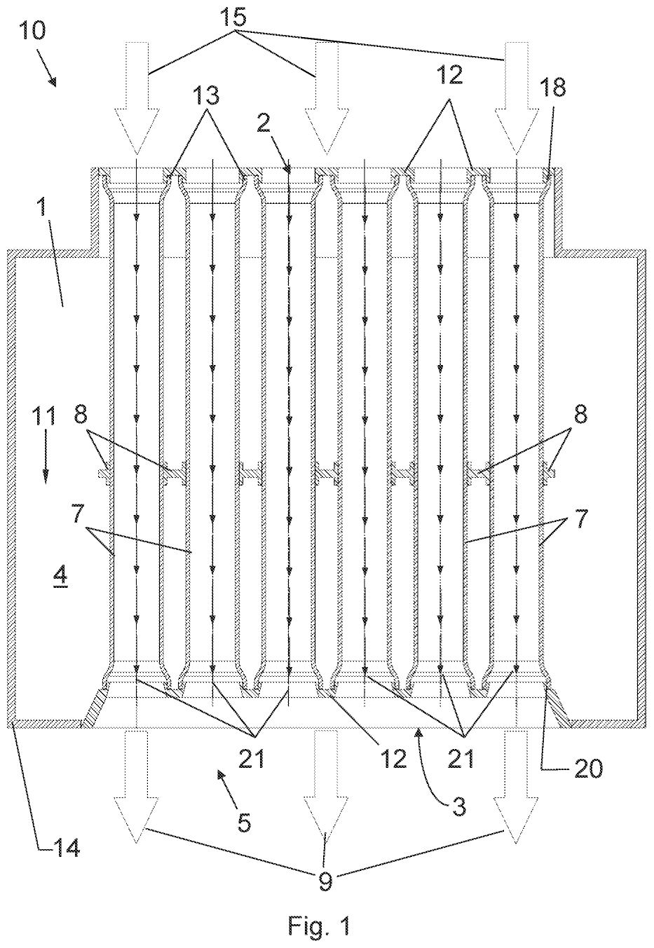

FIG. 1 shows an air vent 10 with adjustable air-outflow direction 9. In the embodiment of the invention presented here, the air vent 10 is configured as a flat or joint vent whose height is smaller than its width, for instance, a height-to-width ratio of about 1:6 to about 1:7. The air vent can also be arranged so as to run orthogonally or even diagonally, for example, in a vehicle.

An airstream 15 can flow in via an air inlet opening 2 of a flow channel 1 into the air vent 10 and flow out of the flow channel 1 via an air outlet opening 3 situated essentially opposite from the air inlet opening 2.

The air vent 10 here has a housing 14 with the air inlet opening 2 and the air outlet opening 3. A constriction—not shown—of the flow channel 1 in the area between the air inlet opening 2 and the air-deflection area 4 can be provided in the housing 14.

In a likewise not shown embodiment, for purposes of improving the laminar flow of the airstream 15 or of the partial streams 21, the housing 14 can widen in the air-deflection area 4, especially so as to be curved convexly outwards.

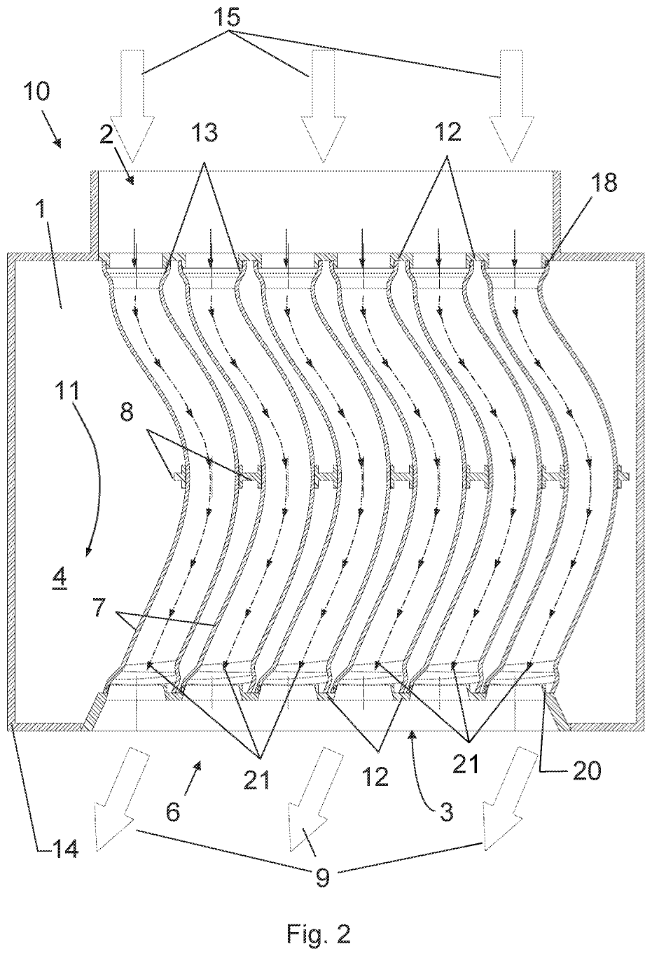

In each case, the direction of flow of the airstream 15 is indicated by arrows in FIGS. 1 and 2.

For example, installation of the air vent 10 in the dashboard of a motor vehicle allows a temperature-controlled airstream 15 to be fed to the air vent 10 via the air inlet opening 2. The airstream 15 can then be deflected and regulated in the air vent 10 in such a way that the directed airstream 15 desired by the user is prevalent in the motor vehicle.

For this purpose, between the air inlet opening 2 and the air outlet opening 3, an air-deflection area 4 is provided in which the airstream 15 is adjusted in order to set the air-outflow direction 9 at the air outlet opening 3.

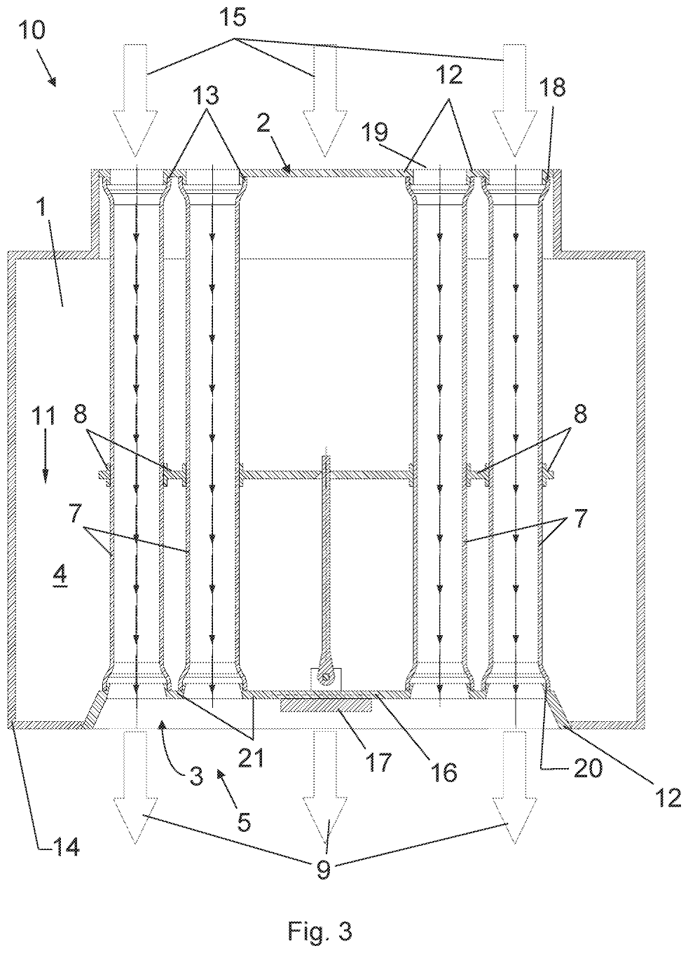

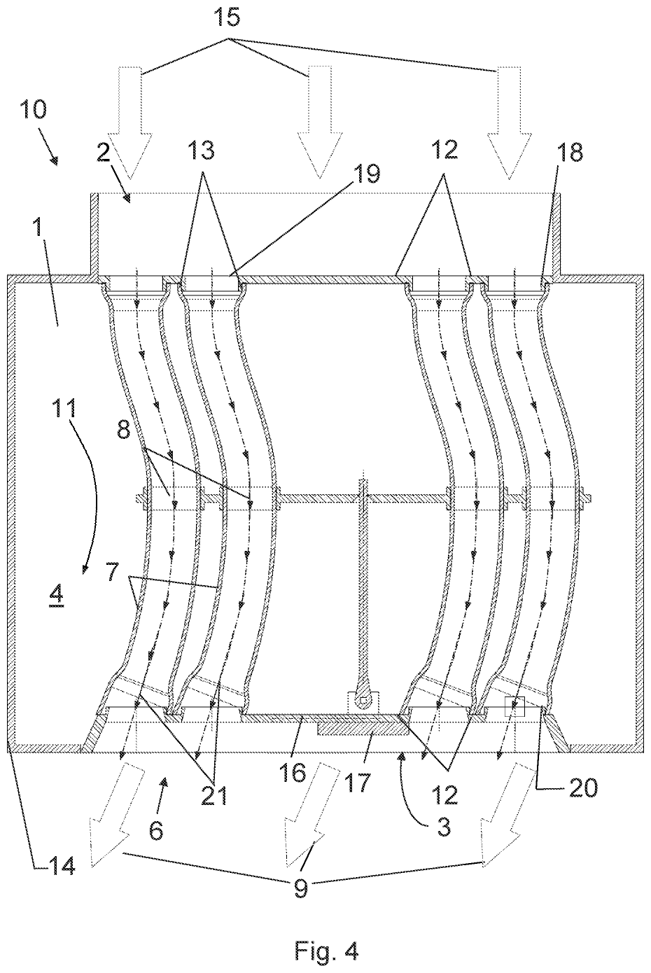

In this context, several, in this case six, regulation means 7 that serve to influence the flow channel geometry are arranged in the air-deflection area 4. These regulation means 7 for guiding the airstream 15 are configured here so as to be elastically deformable and essentially tubular in shape, as is shown in FIGS. 1 and 2 as well as in FIGS. 3 and 4.

The airstream 15 is preferably not only adjusted but also split into partial streams 21 by the regulation means 7. This splitting takes place in that the airstream 15 flows through the air inlet opening 2 into the tubular regulation means 7 and is then split into an appropriate number (here six) of partial streams 21. Naturally, a different number of regulation means 7 is likewise conceivable. Due to the appertaining geometry of the regulation means 7, these partial streams 21 are correspondingly guided and directed in the flow channel 1.

The regulation means 7 here are formed by elastic tube elements, preferably silicon tubes, arranged essentially parallel to each other, as is shown in FIGS. 1 and 2 as well as in FIGS. 3 and 4.

The regulation means 7 extend in the flow channel 1 essentially from the air inlet opening 2 to the air outlet opening 3. In this manner, the partial streams 21 flow into the regulation means 7 from the air inlet opening 2 to the air outlet opening 3.

In the basic position 5 which is shown in FIG. 1 and in which the airstream 15 or the partial streams 21 flow essentially undeflected from the air inlet opening 2 to the air outlet opening 3, the at least one regulation means 7 extends essentially parallel to the flow direction 11 of the airstream 15 or of the partial streams 21 between the air inlet opening 2 and the air outlet opening 3.

FIG. 1 also shows an adjustment element 8 which is operationally connected to the at least one elastically deformable regulation means 7 that serves to set the air-outflow direction, and which serves to reversibly change the geometric shape of the at least one regulation means 7.

Accordingly, the regulation means 7 are adjustable by means of the adjustment element 8 between the basic position 5, in which the airstream 15 or the partial streams 21 flow essentially undeflected from the air inlet opening 2 to the air outlet opening 3, and a deflected position 6, in which the geometry of the regulation means 7 is reversibly deformed. The deflected position 6 of the regulation means 7 is shown in FIG. 2.

The adjustment element 8 can be deflected in at least one direction (Y) and in another direction (Z) that is perpendicular to this direction (Y) in order to change the geometric shape of the at least one reversibly changeable regulation means (7) on at least two planes that are preferably situated approximately perpendicular to each other.

As can also be seen FIGS. 1 and 2, the air vent 10 has at least one receptacle means 12 for the regulation means 7. Here, a first end 13 of the regulation means 7 is held in these receptacle means 12. In this manner, the regulation means 7 are securely held in the air vent 10.

The receptacle means 12 can be moved, especially slid, relative to the housing 14 of the air vent 10 in order to allow a linear compensation in the case of a reversible change in the geometric shape of the regulation means 7.

As can also be seen in FIG. 1, the receptacle means 12 here are configured as bearing points 18, 20 for the regulation means 7. In other words, the regulation means 7 are held in the flow channel 1 in the area of its leading edge 19 by bearing points 18, and by bearing points 20 in the area of the air outlet opening 3, as shown in FIGS. 1 and 2.

Here, the receptacle means 12 can be made of “hard” plastic, in contrast to which the regulation means 7 can be made of “soft” plastic such as, for instance, silicon, TPE or TPU. The receptacle means 12 configured as bearing points 18, 20 ensure a linear compensation of the regulation means 7 at the air inlet opening 2. The receptacle means 12 have the additional function of a visible part, situated on the air outlet opening 3, an aspect that is advantageous for esthetic or design reasons.

The reversibly deformable regulation means 7 can be made of an elastomer, especially a thermoplastic elastomer (TPE), preferably a polyurethane-based thermoplastic elastomer (TPU), or else it contains an elastomer.

FIGS. 3 and 4 show a second embodiment of an air vent 10. The structure and the mode of functioning of the air vent 10 according to FIGS. 3 and 4 correspond essentially to those as shown in FIGS. 1 and 2. The second variant differs from the first embodiment variant as shown in FIGS. 1 and 2 in that an additional center lamella 16 is provided which is at the end of the air-deflection area 4 of the partial streams 21 in the flow direction 11.

By the same token, FIGS. 3 and 4 depict an operating element 17 that is arranged especially in the area of the air outlet opening 3, that serves to set the direction of the airstream 15 or of the partial streams 21 and that is coupled to the adjustment element 8.

The center lamella 16 is also coupled to the operating element 17. It is conceivable for the operating element 17 to have a gearwheel or toothed segment, so that this connection can be implemented in the form of a gearwheel connection.

Due to the center lamella 16, the airstream can be additionally deflected in a flow direction perpendicular or crosswise to the partial streams 21. As seen from the perspective of a user, for example, in a motor vehicle, the airstream can be deflected by means of the operating element 17 or the center lamella 16, for instance, to the side, in other words, to the left and to the right.

In such a case, the flow direction established by the air-deflection area and by the regulation means 17 would run approximately orthogonally thereto, in other words, upwards and downwards, so that a deflection of the airstream 15 is possible in the horizontal direction, in other words, also in the vertical direction relative to the outlet opening of the air vent 10, that is to say, air deflection is possible in all spatial directions.

As set forth in the invention, it would also be conceivable for the air vent 10 to be arranged in such a way that, from the operator's perspective, the deflection in the vertical direction, in other words, from the top to the bottom, brought about by the center lamella 16, and the deflection direction effectuated by the regulation means 7 are then in the horizontal direction as seen by the user.

FIG. 3 shows the air vent 10 in a basic position 5 that corresponds to the position as shown in FIG. 1. FIG. 4 depicts the deflected position 6 of the air vent 10.

### LIST OF REFERENCE NUMERALS

1 flow channel
2 air inlet opening
3 air outlet opening
4 air-deflection area
5 basic position
6 deflected position
7 regulation means
8 adjustment element
9 air-outflow direction
10 air vent
11 flow direction
12 receptacle means
13 first end of regulation means
14 housing
15 airstream
16 center lamella
17 operating element
18 bearing point
19 leading edge
20 pivot point
21 partial streams

1. An air vent with adjustable air-outflow direction, comprising:
a flow channel having an air inlet opening and an air outlet opening located substantially opposite from the air inlet opening, wherein an airstream can flow in a direction through the air inlet opening into the flow channel and then out through the air outlet opening;
an air-deflection area arranged between the air inlet opening and the air outlet opening configured to set air-outflow direction at the air outlet opening;
at least one regulation means in the air-deflection area and arranged in the flow channel that is configured to influence geometry of the flow channel, wherein the at least one regulation means is configured so as to be elastically deformable and substantially tubular in shape and splits the airstream into partial streams that are guided by and flow through the regulation means.

2. The air vent according to claim 1, wherein the at least one regulation means comprises two or more elastic tubular elements that are arranged substantially parallel to each other.

3. The air vent according to claim 1, wherein the at least one regulation means extends in the flow channel substantially from the air inlet opening to the air outlet opening, and when the at least one regulation means is in a basic position, the partial streams flowing or being guided through the regulation means flow from the air inlet opening to the air outlet opening substantially without being deflected.

4. The air vent according to claim 1, further comprising an adjustment element that is operationally connected to the at least one elastically deformable regulation means and that serves to reversibly change the geometric shape of the at least one regulation means.

5. The air vent according to claim 4, wherein the adjustment element is adapted to be deflected in at least one direction (Y) and in another direction (Z) that is perpendicular to the direction (Y) in order to change the geometric shape of the at least one reversibly changeable regulation means on at least two planes that are preferably situated approximately perpendicular to each other.

6. The air vent according to claim 4, wherein the adjustment element is adapted to set the regulation means between a basic position in which the airstream or the partial streams flow from the air inlet opening to the air outlet opening substantially without deflection, and a deflected position in which the geometry of the at least one regulation means is reversibly deformed with respect to the basic position.

7. The air vent according to claim 4, wherein, in order for the direction of the airstream or of the partial streams to be set, an operating element arranged in the area of the air outlet opening is coupled to the adjustment element.

8. The air vent according to claim 1, further comprising a housing for the air inlet opening and the air outlet opening, wherein the housing widens or is curved convexly outwards in the air-deflection area for purposes of improving laminar flow of the partial streams.

9. The air vent according to claim 8, further comprising at least one receptacle means for the at least one regulation means, wherein the at least one receptacle means is movable or slidable relative to the housing of the air vent in order to allow a linear compensation in the case of a reversible change in the geometric shape of the at least one regulation means.

10. The air vent according to claim 9, wherein the at least one regulation means is held in the flow channel in the area of its leading edge by at least one bearing point configured as a receptacle means and/or by at least one bearing point configured as a receptacle means in the area of the air outlet opening.

11. The air vent according to claim 1, wherein a center lamella is provided in the flow direction at the end of the air-deflection area of the partial streams, and wherein the operating element is coupled to the center lamella.

12. The air vent according to claim 1, wherein the at least one reversibly deformable regulation means is made of an elastomer or contains an elastomer selected from the group consisting of a thermoplastic elastomer (TPE) and a polyurethane-based thermoplastic elastomer (TPU).

13. A method for directing an airstream through an air vent, comprising:
providing an air vent according to claim 1;
introducing the airstream into a flow channel via an air inlet opening of the air vent;
reversibly changing geometric shape of the at least one substantially tubular regulation means in the air vent so as to change the geometry of the flow channel, particularly so that partial streams flowing through the regulation means are split and guided before the partial streams exit the air vent via the outlet opening.

14. The method for directing an airstream according to claim 13, wherein the reversible change in the geometric shape is an elastic deformation of the regulation means.

15. The method for directing an airstream according to claim 14, wherein the elastic deformation of the regulation means is influenced by the airstream in an air-deflection area in the flow channel of the air vent.
